(19) United States
(12) Patent Application Publication
(10) Pub. No.: US 2017/0334749 A1
(43) Pub. Date: Nov. 23, 2017

(54) CAPACITOR DISCHARGE WELL TREATMENT DEVICE AND METHODS OF USE

(71) Applicant: David W. Traut, Sartell, MN (US)

(72) Inventor: David W. Traut, Sartell, MN (US)

(21) Appl. No.: 15/478,648

(22) Filed: Apr. 4, 2017

Related U.S. Application Data
(60) Provisional application No. 62/317,739, filed on Apr. 4, 2016.

(51) Int. Cl. C02F 1/46; C02F 1/461

(52) U.S. Cl. CPC C02F 1/4608; C02F 1/46114; C02F 2303/06; C02F 2201/46135; C02F 2001/46152; C02F 2303/22; C02F 2303/04

(57) ABSTRACT

A method for treating slime-forming bacteria within a water well, including providing a capacitor discharge well treatment device, introducing the capacitor discharge well treatment device into a well water source, powering the capacitor discharge well treatment device with a high voltage current, and subjecting slime-forming bacteria within the well water source to the high voltage current.

### TECHNICAL FIELD

The present application is generally related to a water well treatment device and associated methods of use, and more particularly to a high voltage capacitor discharge device and associated methods for the treatment of water wells.

### BACKGROUND

The statements set forth in this section provide background information related to the present invention and should not be construed as constituting prior art or in any way limiting the scope of the disclosed invention.

Many water wells are tapped into aquifers containing a variety of species of slime-forming bacteria such as, for example, Gallionella ferruginea and some Protozoans. When these living organisms enter the water well, they are exposed to an oxygen and nutrient-rich environment that permits the organisms to feed on the iron and manganese attached to the interior parts of the well and its pump components. This process leads to the rapid colonization of the slime-forming bacteria and, as a result, the well's capacity to efficiently operate is reduced as the organisms physically obstruct and/or create a biofilm covering various operational components. For instance, Gallionella ferruginea are linear-linking or stalk-type growth organisms that can plug the screen of the water well or insulate the pump motor with iron slime deposits (sometimes over an inch thick), which in turn can cause the associated equipment to overheat and experience a shortened life cycle.

Current industry processes for reducing or eliminating slime-forming bacteria in water wells typically involve periodically treating the well water after formation of the bacteria by using a variety of brushing tools and/or chemicals designed to work as a cleaning agent and disinfectant. However, after cleaning, slime-forming bacteria quickly begin to reappear when new water is pumped into the well, thereby restarting the rapid colonization problem.

Since it is impractical to change the characteristics of the well water, there is a need to develop and utilize equipment that is designed to prevent iron and manganese from forming in the water well. The present application is intended to improve upon and resolve some of these known problems within the art.

### SUMMARY

According to one aspect of the present invention, a method for treating slime-forming bacteria within a water well is provided. In accordance with this embodiment, the method comprises the steps of providing a capacitor based well treatment device; introducing the capacitor based well treatment device into a well water source; powering the capacitor based well treatment device with a high voltage current; and subjecting slime-forming bacteria within the water source to the high voltage current.

### BRIEF DESCRIPTION OF THE DRAWINGS

The above-mentioned aspects of the present application and the manner of obtaining them will become more apparent, and the teachings themselves will be better understood by reference to the following description of illustrative embodiments taken in conjunction with the accompanying drawings, wherein:

FIG. 1 illustrates a well treatment system in accordance with one embodiment of the present invention.

FIG. 2 is a magnified image of slime-forming bacteria within a water well before treatment with the system and method of the present invention.

FIG. 3 is another magnified image of slime-forming bacteria within a water well before treatment with the system and method of the present invention.

FIG. 4 is a magnified image of slime-forming bacteria within a water well after treatment with the system and method of the present invention.

FIG. 5 is another magnified image of slime-forming bacteria within a water well after treatment with the system and method of the present invention.

Corresponding reference characters indicate corresponding parts throughout the figures. Although the exemplification set forth herein illustrates embodiments of the invention, the disclosed embodiments are not intended to be exhaustive or to be construed as limiting the scope of the invention.

### DETAILED DESCRIPTION

The embodiments of the present invention described below are not intended to be exhaustive or to limit the invention to the particular forms disclosed in the following detailed description. Rather, the embodiments are chosen and described so that those skilled in the art may appreciate and understand the principles and practices of the present invention.

In this regard, the invention is illustrated in the several figures, and is of sufficient complexity that the many parts, interrelationships, and sub-combinations thereof simply cannot be clearly or meaningfully illustrated in a single patent-type drawing. Accordingly, several of the drawings show in schematic, or omit, parts that are not essential in that drawing to a description of a particular feature, aspect or principle of the invention being disclosed. Thus, the best mode of one embodied feature may be shown in one drawing, and the best mode of another feature will be called out in another drawing.

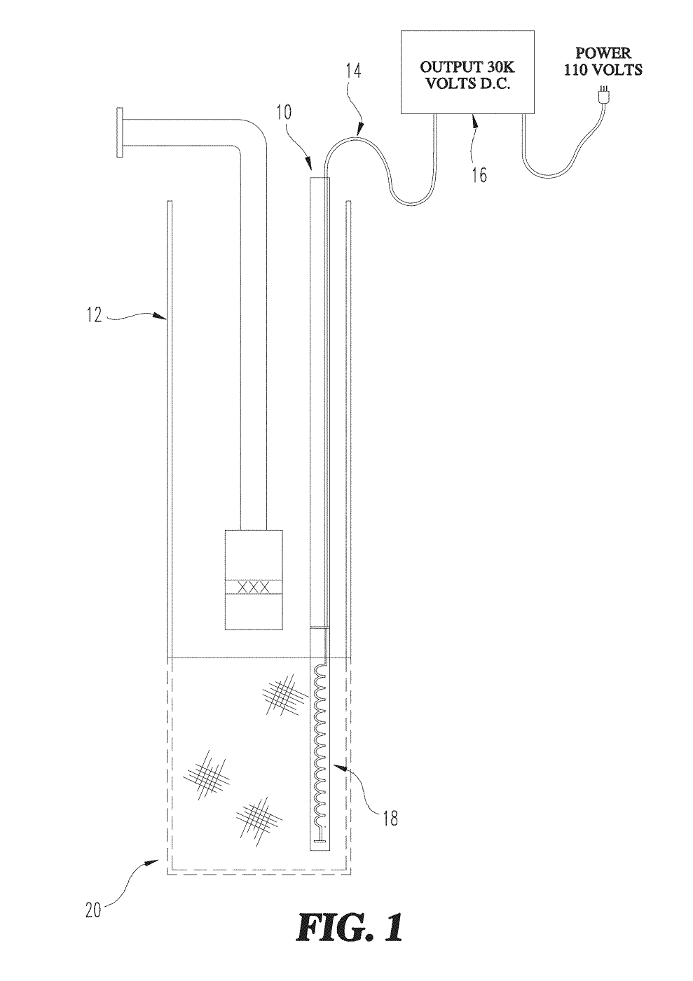

As is generally known within the art, mineral and biological colloidal particles present in untreated well water sources can result in the formation of biofilms that adhere to any exposed surface surrounding the well water source. The present invention uses a high voltage capacitor discharge unit to alter the surface charge of the particles present in a water well, thereby preventing or reducing the attachment of the particles to the wetted surfaces within the well, its pump and filter components. It has been determined that such a system causes the organisms to stay fluid, thereby freely pumping through the system without attaching to and colonizing on the walls of the water well or its associated pump and filter components. To accomplish this, and with specific reference to FIG. 1, a capacitor discharge well treatment device 10 is placed into and mounted within a water well 12. In accordance with certain aspects of the invention, the capacitor treatment device 10 is an insulated electrode that is configured to produce a capacitive layer across the water contained within the well. In particular, an electrostatic field and corresponding capacitor is created within the well via implementation of the capacitor treatment device 10. However, the insulated layer between the water and the electrode prevents any electrical current from flowing across or through the body of the electrode and into the water, which could otherwise cause a current leakage or short through the body of water.

At sufficiently high DC voltage levels, the capacitive charge of the capacitor treatment device 10 produces a field across the water that influences the surface charge of all wetted surfaces of the well and the pump and filter components. In accordance with certain aspects of the invention, a DC voltage of approximately 30,000 Volts is particularly useful. To produce the voltage, a high-voltage cable or wire 14 is electrically connected to a power source 16. The wire 14 runs through the electrode device to a capacitor discharge assembly 18 located adjacent the end of the device. In accordance with certain aspects of the invention, the capacitor discharge assembly 18 can be placed near a well inlet screen 20 to prevent biofilm from developing on or around the screen 20. According to other aspects of the invention, the capacitor treatment device 10 includes a tube extension such as, for example, a 1″ PVC tube extension.

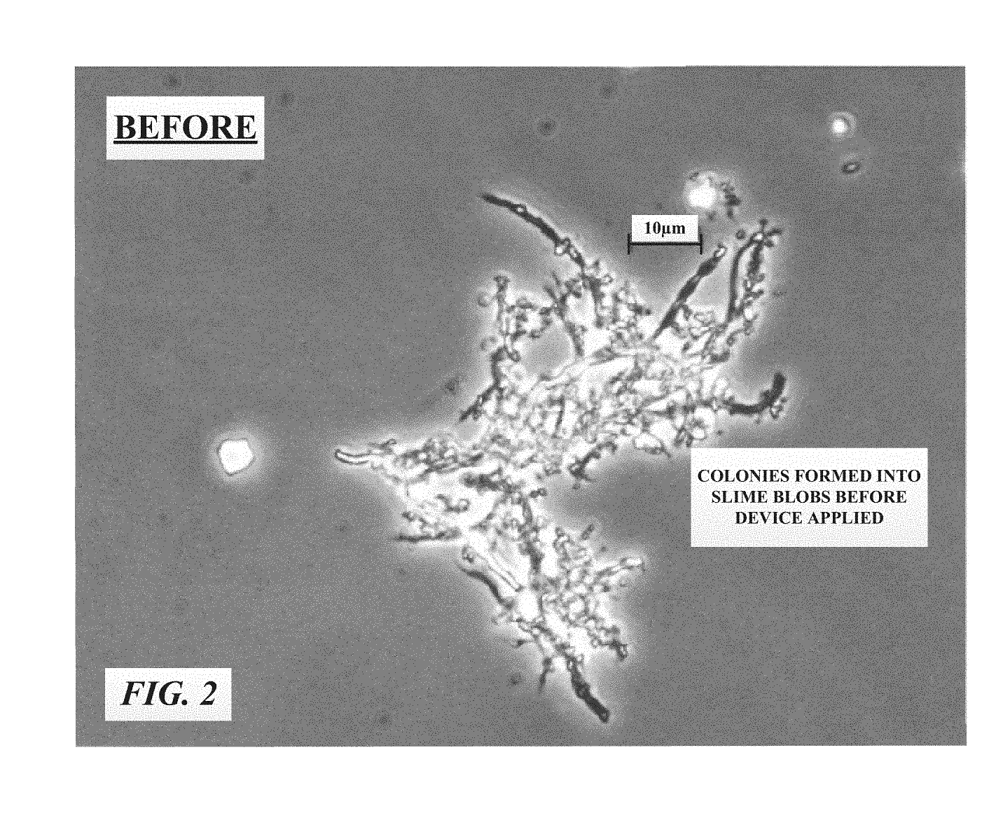

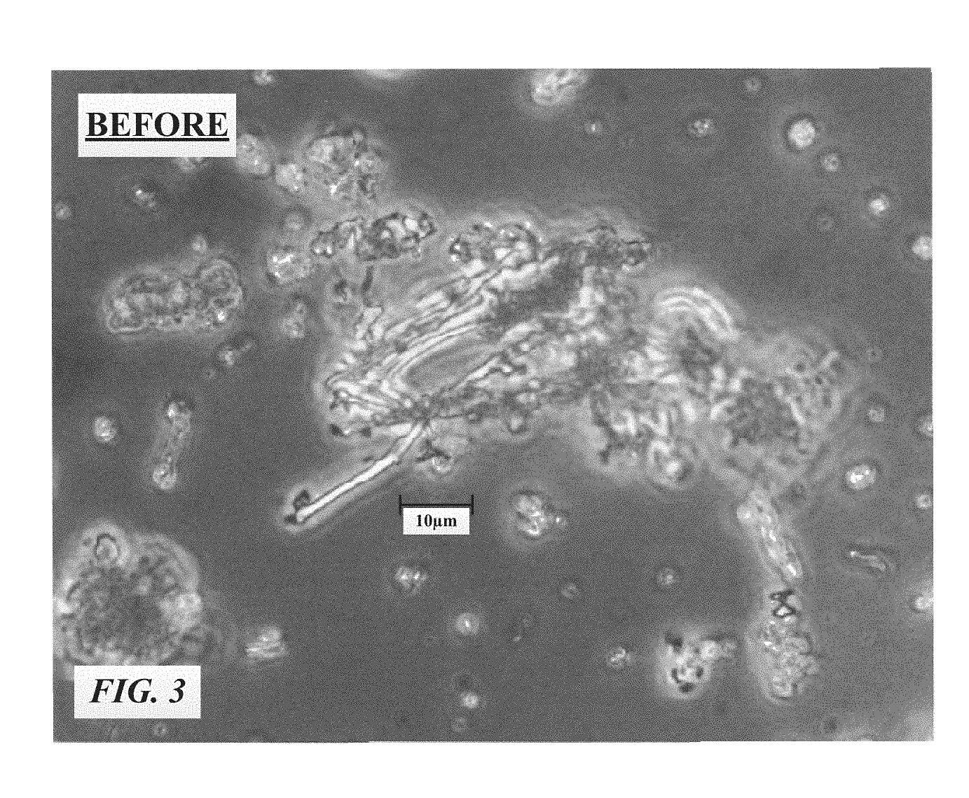

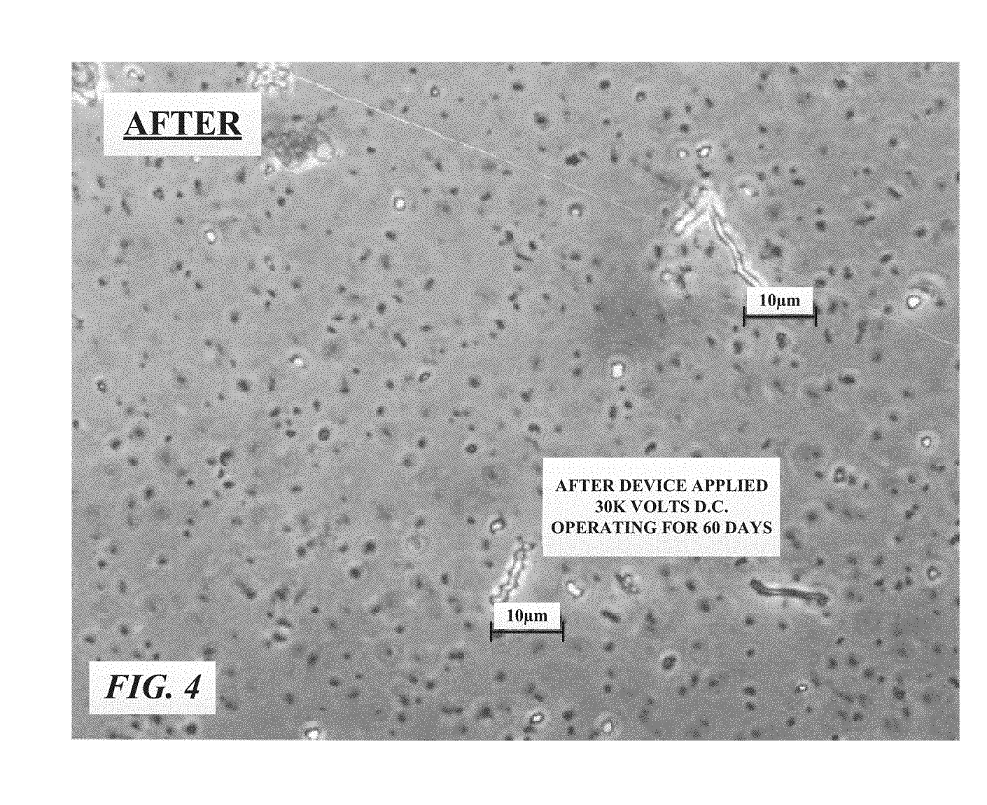

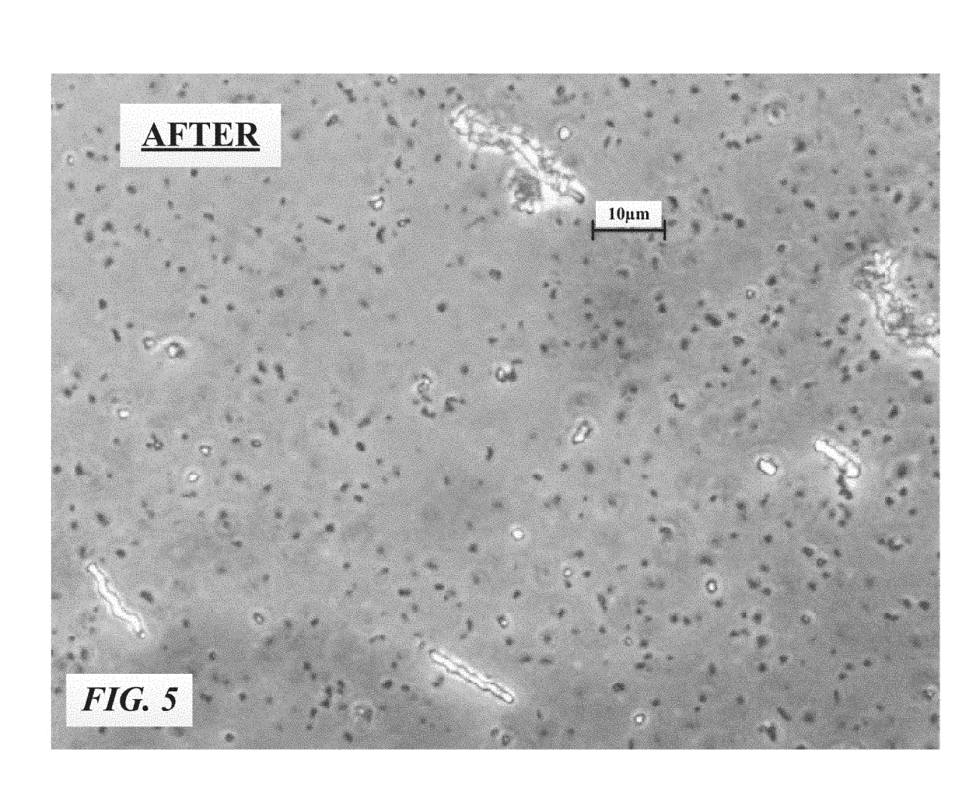

Referring to FIGS. 2 and 3, show therein are magnified images of slime-forming bacteria within the water well before being treated with the capacitor treatment device 10 in accordance with the teachings of the present invention. In these images, colonies of bacteria form into blobs of slime. Referring to FIGS. 4 and 5, shown therein are magnified images of the slime-forming bacteria after being subjected to a high voltage capacitor unit (i.e., the capacitor treatment device 10) in accordance with one embodiment of the present invention at 30,000 Volts D.C. for 60 days.

As can be seen from comparing FIGS. 2 and 3 with FIGS. 4 and 5, when blobs of slime are subjected to the high voltage capacitor unit, the capacitor discharge alters the natural surface charge of the suspended particles, thereby preventing the particles from sticking or clinging to the surfaces of the water well (including the pump and filter components) or agglomerating into scale or biofilm on such surfaces. Instead, the particles separate into stable suspensions from the increased electrostatic repulsion between the particles as a result of the capacitor unit. By stabilizing the dispersion of suspended particles and colloidal substances in the water, the capacitor unit interferes with the ability of the microbes to attach to the well's wetted surfaces, thereby preventing the proliferation of biofilm and the formation of slime.

The teachings and aspects of the present invention are further enhanced by the following illustrative experiments. According to this experiment, a Biological Activity Reaction Test (BART) test was performed to monitor the population size and activity of specific groups of iron bacteria after water sample were subjected to the methods of the present invention. The water was observed as being clear with a few rusty flecks present. Specifically, the BART test results showed the presence of gas bubbles and about ⅜″ of rusty sediment. Motile and non-motile rod-shaped bacteria were predominate. Numerous amorphous granular gray particulates including some rods and inorganic and organic material were also observed. However, significantly fewer iron bacteria were visible than were present in the initial water sample. The microscopy results indicated a few iron-encrusted stalks or sheaths among the particulate iron. However, Gallionella was not observed.

In a second BART test, the water sample was observed as being rusty with deposit. Gas bubbles were present, as well as a thin black deposit on parts of the floating ball and the plastic tube in the vicinity of the ball. The water was rusty orange with some black sediment in the cone of the tube. Amorphous gray granular pieces were scrapped off the black area of the tube. Fewer iron bacteria were visible after 7 days of incubation compared to the initial sample. The water was turbid and rusty overlaying about ¼″ of orange deposit. The microscopy results showed a variety of iron bacteria present, including a few Gallionella. A few flagellated protozoans were also swimming among the particulate.

While exemplary embodiments incorporating the principles of the present disclosure have been disclosed herein, the present disclosure is not limited to the disclosed embodiments. Instead, this application is intended to cover any variations, uses, or adaptations of the disclosure using its general principles. Further, this application is intended to cover such departures from the present disclosure as come within known or customary practice in the art to which this invention pertains.

1. A method for treating slime-forming bacteria within a water well, comprising:
providing a capacitor discharge well treatment device;
introducing the capacitor discharge well treatment device into a well water source;
powering the capacitor discharge well treatment device with a high voltage current; and
subjecting slime-forming bacteria within the well water source to the high voltage current.

2. The method of claim 1, wherein the step of introducing the capacitor discharge well treatment device into a well water source comprises submerging the capacitor discharge well treatment device into the well water source.

3. The method of claim 1, wherein the step of providing the capacitor discharge well treatment device comprises introducing an insulated electrode device into the well water source.

4. The method of claim 1, wherein the step of powering the capacitor discharge well treatment device with a high voltage current comprises powering the capacitor discharge well treatment device with about 30,000 Volts.
